(19) United States
(12) Patent Application Publication
(10) Pub. No.: US 2005/0251410 A1
(43) Pub. Date: Nov. 10, 2005

(54) Price presentation in an online e-commerce system

(76) Inventor: Michael R. Kahn, Westampton, NJ (US)

Correspondence Address: MICHAEL R. KAHN, 60 DOVER ROAD, WESTAMPTON, NJ, 08060, US

(21) Appl. No.: 11/120,761

(22) Filed: May 3, 2005

Related U.S. Application Data
(60) Provisional application No. 60/569,419, filed on May 8, 2004.

(51) Int. Cl. G06F 17/60

(52) U.S. Cl. 705/1

(57) ABSTRACT

A method and system for information presentation in an online trading environment are described. According to one aspect of the invention, the sales price of the item, plus any applicable taxes, shipping, and any applicable payment surcharge are included in the total cost displayed for each item. The list of items may optionally be sorted according to the total cost of the item. According to another aspect of the invention, the sales price of the item plus any applicable taxes and payment surcharges are included in the total cost displayed for each item, but the shipping charges are not included, thereby providing an accurate total cost when the item will be received in-person, thereby avoiding shipping charges.

### CROSS REFERENCE TO RELATED PUBLICATIONS

This application claims the benefit of U.S. Provisional Application No. 60/569,419, filed May. 8, 2004 and is incorporated herein in its entirety.

U.S. Pat. No. 5,710,887 is incorporated herein by reference.

U.S. Pat. No. 6,058,417 is incorporated herein by reference.

U.S. Pat. No. 6,360,273 is incorporated herein by reference.

U.S. Pat. No. 6,414,320 is incorporated herein by reference.

U.S. Pat. No. 6,523,037 is incorporated herein by reference.

U.S. Pat. No. 6,604,107 is incorporated herein by reference.

U.S. Patent Application 20030074435 is incorporated herein by reference.

U.S. Patent Application 20040039733 is incorporated herein by reference.

### FIELD OF THE INVENTION

The invention relates generally to the field of online commerce. More particularly, the invention relates to information presentation and management in an online trading environment, such as an online shopping site, an online auctioning site, an online e-commerce site, an online person-to-person trading site, or the like.

### RELATED ART

More and more Internet users are realizing the ease and convenience of buying and selling online. As a result, collectors, hobbyists, small dealers, unique item seekers, bargain hunters, and other consumers, are able to buy and sell millions of items at various online shopping sites. The success of an online shopping site depends upon its ability to provide an enjoyable shopping experience and an easy-to-use environment in which buyers and sellers can conduct business efficiently. Current online shopping sites have certain limitations in the manner in which they present information to users. For example, FIG. 1 shows an exemplary embodiment of a listing of items available for sale that are presented to a prospective buyer in an online e-commerce system. For the purposes of this disclosure, this type of listing will be referred to as a “multi-item listing”. That is, it shows multiple items available for sale, as opposed to a listing that shows details for one particular item. For each item in the multi-item listing, a current price is shown. In the case of an online auction, some items may also include a price for which the item may be purchased immediately, without waiting for the auction end time. This price does not include shipping and applicable taxes. Shipping costs are often paid by the buyer. The seller typically establishes the shipping costs. Sometimes the shipping cost is geography dependent. However, in many cases, a fixed shipping price is established for all buyers, regardless of location. Taxes often depend on the geographical location of the seller and buyer.

In this case, the posted sale price can be misleading. For example, seller Abbey may post an item for sale at $11, and charge $3.95 for shipping. Seller Barney may post an item for sale at $12, and charge $2 for shipping. Therefore, by sorting by selling price, the item for sale by seller Abbey would be shown as lower cost than that for sale by seller Barney. However, the total cost to a buyer is more for the item for sale by Abbey. A seller may try to make his or her item appear at a lower cost to prospective buyers by lowering the item cost, while compensating for the lower listing price with a higher shipping price.

In the light of the foregoing, it is desirable to provide an improved user interface for online commerce sites. In particular, it would be advantageous to enhance the online trading experience by providing buyers with a mechanism to more quickly determine the total cost of items for sale.

### BRIEF SUMMARY OF THE INVENTION

A method and system for information presentation in an online trading environment are described. For the purposes of this disclosure, the term “sales price” refers to the sale price of the item, not including shipping, taxes, or other charges. The term “total cost” refers to the total cost needed to acquire the item. The total cost is the sales price plus all other costs. The other costs may include, but are not limited to, shipping, taxes, and payment surcharges for using a credit card. However, the total cost may not necessarily include all possible other costs. For example, it is possible that the “total cost” for a particular buyer may not include shipping. For example, in many e-commerce sites, it is possible to search for items in a particular geographical area. In some cases, the buyer may be willing to take delivery of the item at the seller's location, thereby eliminating the cost of shipping. This is especially helpful with large items that tend to have higher shipping costs. It is therefore desirable to provide an option to not include the shipping in the total cost. According to one aspect of the invention, a multi-item listing is provided which indicates both the sales price, and the total cost of the item. In another aspect of the invention, the multi-item listing is presented sorted by total cost. According to another aspect of the invention, an indication is provided to the user if sales tax or a payment surcharge, applies to a particular item.

Other features of the present invention will be apparent from the accompanying drawings and from the detailed description that follows.

### BRIEF DESCRIPTION OF THE DRAWINGS

FIG. 1 shows a typical prior art of a multi-item listing presented to a prospective buyer in an online e-commerce system.

FIG. 2 shows a user profile for a prospective buyer.

FIGS. 3A-3E show item profiles for items listed for sale in an online e-commerce system.

FIG. 4 shows an exemplary embodiment of a multi-item listing of the present invention which presents tax information.

FIG. 5 shows an exemplary embodiment of a multi-item listing of the present invention which presents a total cost based on tax and shipping information.

FIG. 6 is a flowchart showing a process of the present invention for generating an item listing.

FIG. 7 is an example of a block diagram of an online e-commerce system.

FIG. 8 is an example of a computer system upon which one embodiment of the present invention may be implemented.

FIG. 9 is a block diagram illustrating an exemplary network-based transaction facility according to embodiments of the present invention.

FIG. 10 is a block diagram showing the input data and output results for total cost calculations in an exemplary embodiment of the present invention.

FIG. 11 shows an exemplary embodiment of an item listing of the present invention which presents a total cost based on tax, shipping, and payment surcharge information.

FIG. 12 shows an exemplary embodiment of an item listing of the present invention which presents a total cost based on tax and payment surcharge information.

### DETAILED DESCRIPTION OF THE PREFERRED EMBODIMENTS

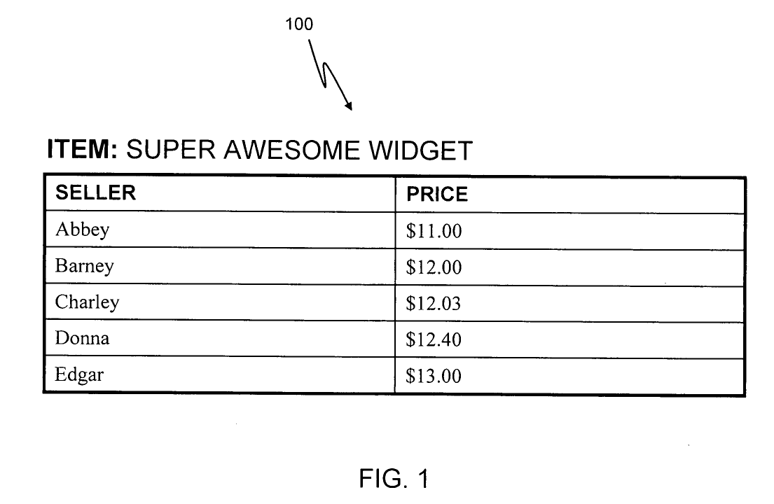

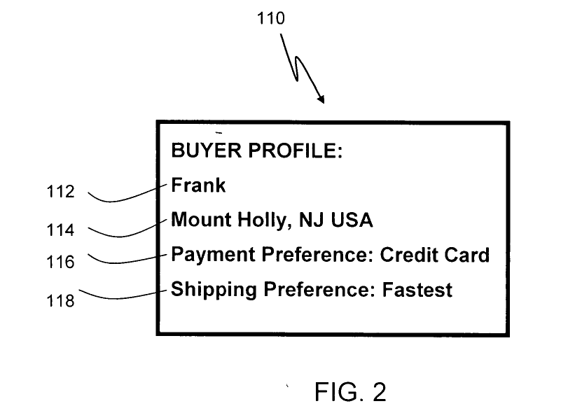

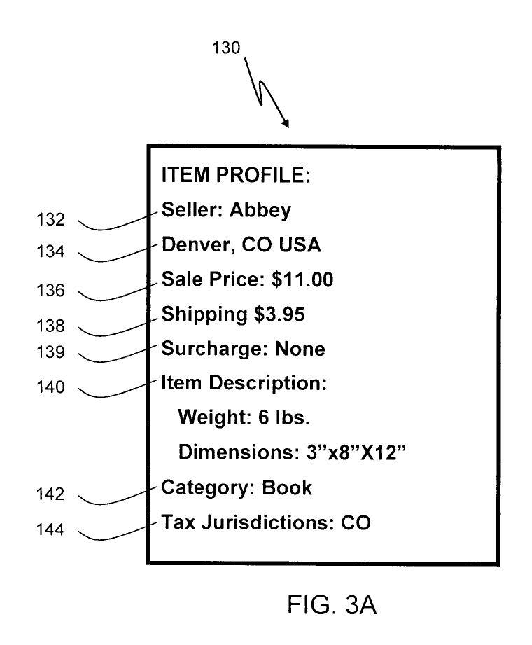

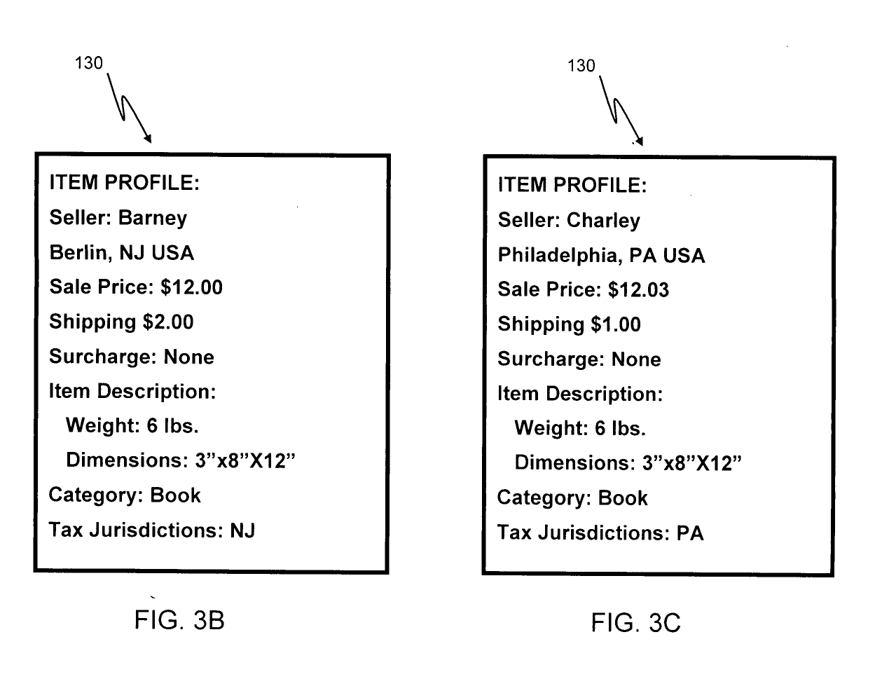

As stated previously, the main objective of the present invention is to provide an accurate assessment of the total cost needed to acquire an item in an online e-commerce system. Referring to FIG. 1, a multi-item listing 100 is shown. It shows a list of multiple items and sellers. The item name, or keywords used in the user's search, is shown at the top. In this case, the keywords used are “SUPER AWESOME WIDGET”. Below the keywords is a listing of various items and an associated price. In this case, only the sale price of the item is considered in the listing. The lowest cost item is indicated as being sold by Abbey. However, other costs such as taxes, shipping, and payment surcharges, can affect the total costs a buyer may incur when purchasing an item. FIG. 2 shows an exemplary buyer profile 110. The buyer profile includes, but is not limited to, the buyer name 112, buyer location 114, payment preference 116, and shipping preference 118. FIG. 2 shows a buyer profile for Frank and shows his state of residence as NJ, his payment preference as credit card, and his shipping preference as fastest. FIGS. 3A-3E show item profiles for various items. The item profile 130 includes, but is not limited to, seller name 132, seller location 134, sale price 136, shipping cost 138, and surcharge 139. The item profile 130 may also include item description 139. This contains descriptive information about the item such as dimensions and weight. This information may be used in calculating shipping charges. The item profile 130 may also include category 142. This may also be used for determining shipping rates, since shipping can also be based on the type of item sold. For example, books are often eligible to be shipped at media mail rates using the United States Post Office. The item profile 130 may also include tax jurisdictions 144. This allows for the designation of one or more tax jurisdictions. In many cases, a sales tax may apply based on the jurisdiction in which the seller and buyer are located. For example, assume a 6% sales tax applies to purchases made by New Jersey residents if the seller is also located in New Jersey. The present invention compares the jurisdiction of both buyer and seller to determine if sales tax is to be applied. FIG. 2 also shows the payment preference as “credit card”. When the buyer profile indicates the payment preference as credit card, the surcharge 139 from the item profile 130 will be used to factor any applicable payment surcharges that result from a credit card transaction fee. A shipping preference is also shown, which can be used in deriving the shipping costs, when multiple shipping options exist. Based on the data provided in FIGS. 2 and 3A-3E, user Frank would have to pay sales tax on the items being sold by Barney and Donna since those sellers are located in New Jersey, as is the buyer, Frank. Taking the sales tax into consideration, a new listing can be presented as shown in FIG. 4. In the example shown in FIG. 4, the taxable items are indicated by the “(T)” next to the seller name of Barney and Donna. However, an icon, or different font style or attribute could also be used to indicate a taxable item.

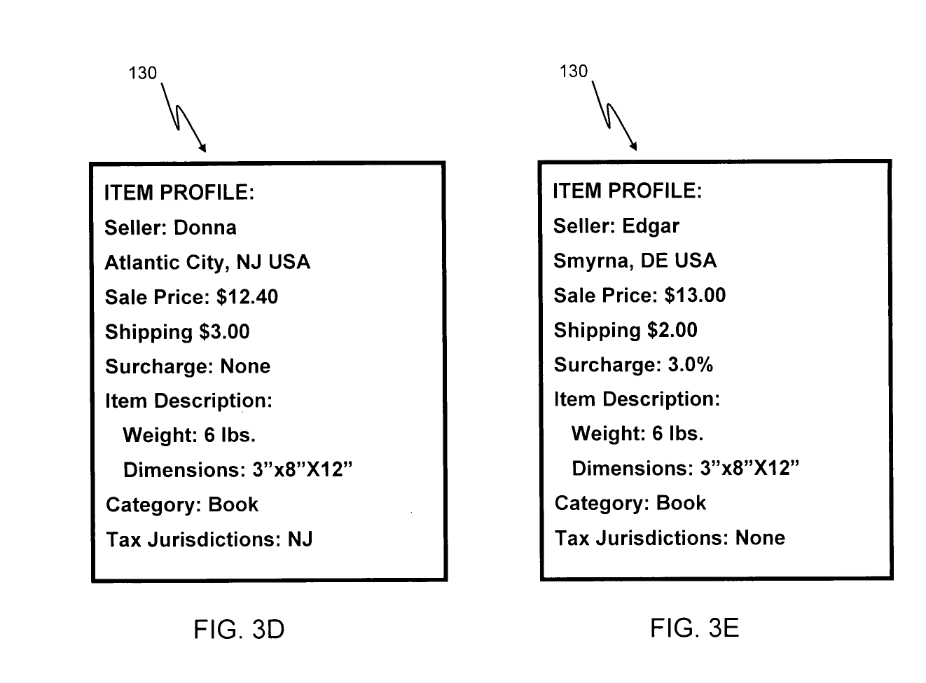

In many cases, a buyer needs to pay shipping costs to receive an item purchased in an online e-commerce system. The seller often establishes shipping charges by stating a fixed price for shipping the item, or by a geography-based charge. In the case of a geography-based charge, the location of the buyer is used in determining the shipping cost. Using the shipping data in FIGS. 3A-3E, along with tax information, a new listing can be presented as shown in FIG. 5. In this example, the true lowest cost item, when considering factors such as sale price, shipping, and tax, is sold by Charley.

Typically, credit card services charge a fee when a transaction is paid for with a credit card. In many cases, the seller absorbs this cost. However, there are cases where the buyer must absorb the cost of an additional payment surcharge for using a credit card. This is indicated by the “Payment Surcharge” field in the item profile of FIG. 3E. In this case, the seller, Edgar, has a policy in which the buyer pays 3.0% of the sales price plus shipping to cover the costs of the credit card transaction fee. The present invention can incorporate this cost into the total cost of the item which is presented to the buyer.

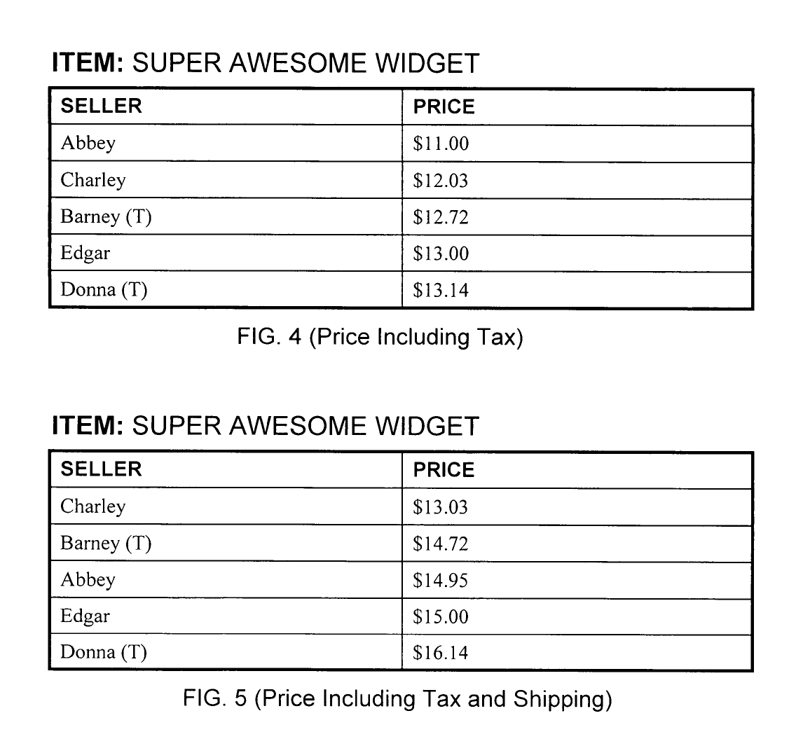

FIG. 6 is a flowchart showing a process of the present invention for generating a multi-item listing. For the purposes of FIG. 6, the user is a buyer. In step 1602 a buyer logon process is initiated. Upon successful login, the buyer profile is retrieved from database storage in step 1604. Results from a user-initiated search are returned in step 1608. In step 1612, any applicable tax is calculated by checking for tax rules, then applying the associated tax. The rules may be based on the type of item. For example, in New Jersey, clothing is usually not subject to sales tax. The rules may also be based on geography, such as both seller and buyer residing in the same state. The sales tax can then be added to the sale price to get the sales-plus-tax price of the item. In step 1616, the shipping is then calculated. The shipping is often fixed for a particular item, regardless of buyer location. In other cases, the shipping may be calculated by considering the city or zip code of the buyer and seller to determine an appropriate shipping rate. Shipping can also be based on the type of item sold. For example, books are often eligible to be shipped at media mail rates using the United States Post Office. Additional payment surcharges, such as those used to cover the costs of credit card transaction fees are calculated in step 1620. The taxes, shipping costs, and any other surcharges are combined with the sale price to form a total cost in step 1624. This total cost represents all the sum of all costs that must be incurred by a buyer to obtain the desired item. By presenting the multi-item list sorted by total cost, the buyer is provided with a true assessment of the amount of funds they must use to obtain the desired item. Alternatively, instead of having a user logon, and retrieval of pre-entered user profile data, it is also possible to have a user specify profile data such as geographical location and payment preferences before initiating the search. In this case, there is no need for the user to have an “account” on the online e-commerce system to conduct searches for items.

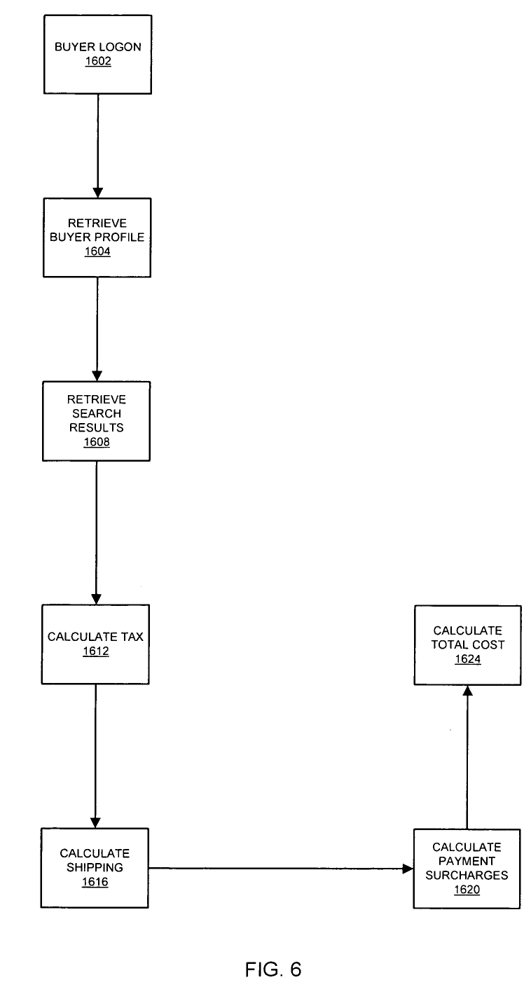

FIG. 7 is a simplified view of an exemplary client-server environment, such as the World Wide Web (the Web), in which online e-commerce may take place. The architecture of the Web follows a conventional client-server model. The terms “client” and “server” are used to refer to a computer's general role as a requester of data (the client) or provider of data (the server). Web clients 205 and Web servers 210 communicate using a protocol such as HyperText Transfer Protocol (HTTP). In the Web environment, Web browsers reside on clients and render Web documents (pages) served by the Web servers. The client-server model is used to communicate information between clients 205 and servers 210. Web servers 210 are coupled to the Internet 200 and respond to document requests and/or other queries from Web clients 205. When a user selects a document by submitting its Uniform Resource Locator (URL), a Web browser, such as Netscape Navigator or Internet Explorer, opens a connection to a server 210 and initiates a request (e.g., an HTTP get) for the document. The server 210 delivers the requested document, typically in the form of a text document coded in a standard markup language such as HyperText Markup Language (HTML).

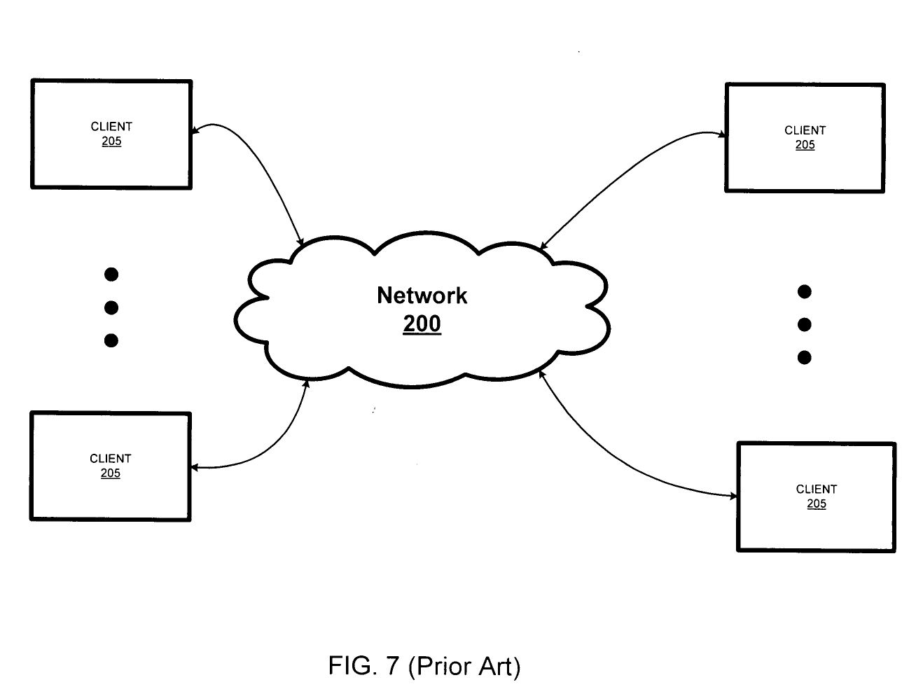

FIG. 8 is a computer system 300 representing an exemplary server which may be utilized in the present invention. Computer system 300 comprises a bus or other communication means 301 for communicating information, and a processing means such as processor 302 coupled with bus 301 for processing information. Computer system 300 further comprises a random access memory (RAM) or other dynamic storage device 304 (referred to as main memory), coupled to bus 301 for storing information and instructions to be executed by processor 302. Main memory 304 also may be used for storing temporary variables or other intermediate information during execution of instructions by processor 302. Computer system 300 also comprises a read only memory (ROM) and/or other static storage device 306 coupled to bus 301 for storing static information and instructions for processor 302.

A data storage device 307 such as a magnetic disk or optical disc and its corresponding drive may also be coupled to computer system 300 for storing information and instructions. Computer system 300 can also be coupled via bus 301 to a display device 321, such as a cathode ray tube (CRT) or Liquid Crystal Display (LCD), for displaying information to a computer user. Typically, an alphanumeric input device 322, including alphanumeric and other keys, may be coupled to bus 301 for communicating information and/or command selections to processor 302. Another type of user input device is cursor control 323, such as a mouse, a trackball, or cursor direction keys for communicating direction information and command selections to processor 302 and for controlling cursor movement on display 321.

A communication device 325 is also coupled to bus 301 for accessing remote servers via a network, such as the Internet, for example. The communication device 325 may include a modem, a network interface card, or other commercially available network interface devices, such as those used for coupling to an Ethernet, token ring, or other type of network. In any event, in this manner, the computer system 300 may be coupled to a number of clients and/or other servers via a conventional network infrastructure, such as a company's Intranet and/or the Internet, for example.

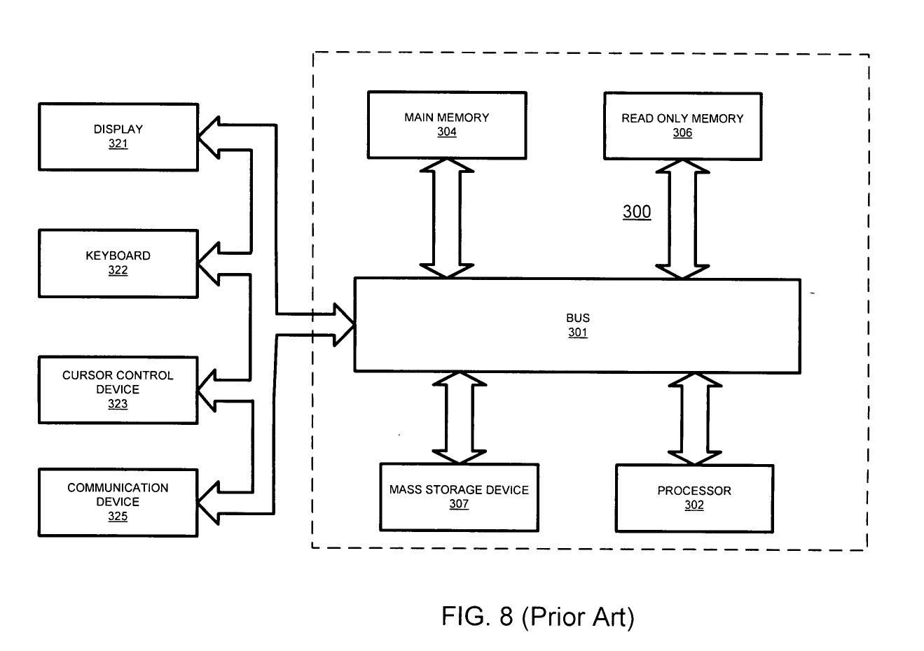

FIG. 9 is a block diagram illustrating an exemplary online e-commerce system in the form of a network-based transaction facility 10 that incorporates embodiments of the present invention. Hereinafter, this network-based transaction facility 10 may be referred to as the “facility”. An exemplary embodiment of the present invention may be implemented within the context of an auction facility, or other person-to-person online e-commerce facility, such as a system to allow private sellers to sell used books to private buyers. However, it will be appreciated by those skilled in the art that the invention will find application in many different types of computer-based, and network-based facilities.

The network-based transaction facility 10 includes one or more of a number of types of front-end servers, namely page servers 12 that deliver web pages (e.g., markup language documents), picture servers 14 that dynamically deliver images to be displayed within Web pages, listing servers 16, CGI servers 18 that provide an intelligent interface to the back-end of facility 10, and search servers 20 that handle search requests to the facility 10. E-mail servers 21 provide, inter alia, automated e-mail communications to users of the facility 10.

The back-end servers include a database engine server 22, a search index server 24, a credit card database server 26, and a price server 39, each of which maintains and facilitates access to a respective database.

The network-based transaction facility 10 may be accessed by a client program 30, such as a browser (e.g., the Internet Explorer distributed by Microsoft Corp. of Redmond, Wash.) that executes on a client machine 32 and accesses the facility 10 via a network such as, for example, the Internet 34. Other examples of networks that a client may utilize to access the facility 10 include a wide area network (WAN), a local area network (LAN), a wireless network (e.g., a cellular network), or the Plain Old Telephone Service (POTS) network. The client machine 32 may be a personal computer, mobile telephone, personal digital assistant (PDA). In fact, the client machine 32 may be any device that can communicate with the facility 10 via the network 200, and is capable of executing an appropriate client program 30.

The information shown in FIGS. 2 and 3A-3E are stored in records in one or more databases within the network-based transaction system 10. The price server 39 is responsible for generating the total cost of the item listing retrieved by the user's search. The price server 39 has a respective database which stores pricing rules. These rules may include, but are not limited to, tax rules for various jurisdictions such as states and countries, and shipping rules for various jurisdictions such as states and countries. The price server 39 communicates with other servers within the network-based transaction facility 10 to obtain needed information regarding the various price calculations.

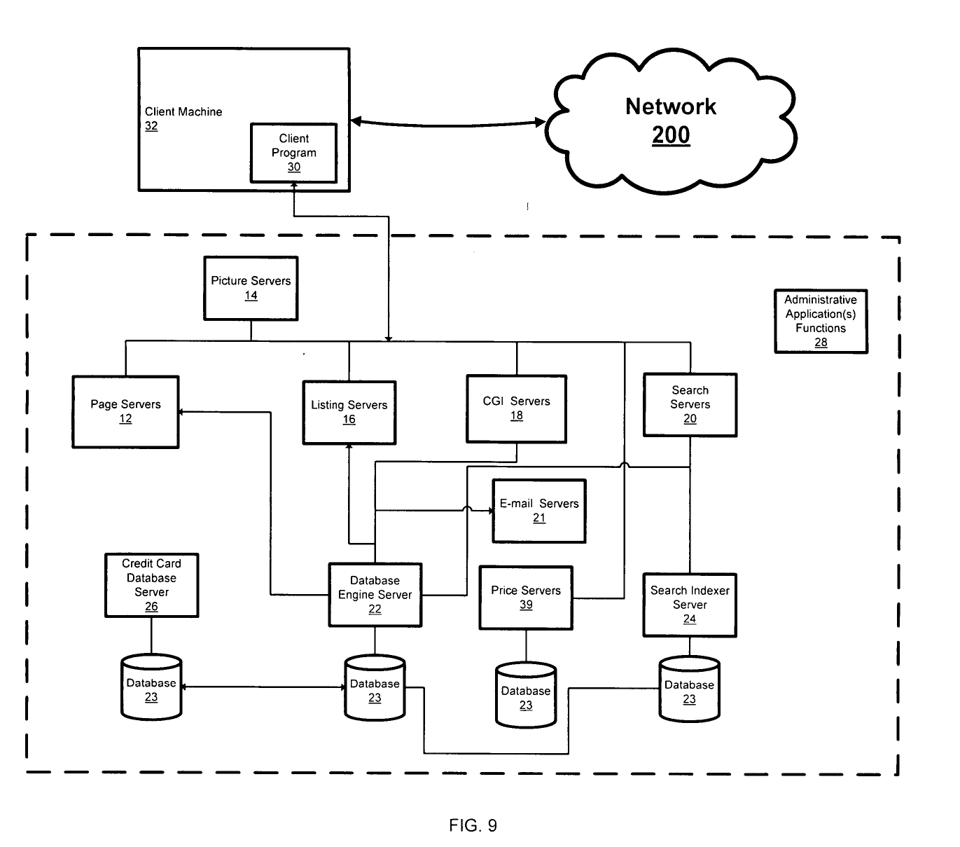

FIG. 10 shows the input data and output results for pricing calculations in an exemplary embodiment of the present invention. The price server 39 executes computer instructions in the form of software which examine various criteria, referred to hereinafter as “pricing rules” 500. These pricing rules accept as input, one or more input parameters, and output the item's total cost 526. The total cost 526 includes the sale price, applicable taxes, shipping costs, payment surcharges, and any other costs that contribute to the total costs that must be incurred by a buyer.

The input parameters may include, but are not limited to, buyer location 504, item category 508, item profile 512, and buyer profile 516. The buyer location 504 may be relevant for both tax calculations and shipping calculations. As stated previously, in many cases, a sales tax may apply based on the jurisdiction in which the seller and buyer are located. The shipping cost may be a fixed amount, but can also depend on the distance between the buyer and the seller. In this case, the buyer address, or associated postal code, such as a U.S. Postal service ZIP code, may be used to derive shipping costs. The item category 508 may also affect tax or shipping costs. For example, in many jurisdictions, a certain type of item, such as clothing or food, is exempt from sales tax. In other cases, a particular item category may have special shipping rates, such as in the case of books, which are usually eligible for U.S. Postal Service media mail rates. Item profile information 512 can also affect tax and shipping costs. This information may include, but is not limited to, size dimensions of the item, weight of the item, sale price of the item, seller location, and payment surcharge information. Many sellers are able to accept credit cards as a form of payment for their transactions. Typically, credit card services charge a fee when a transaction is paid for with a credit card. In many cases, the seller absorbs this cost. However, there are cases where the buyer must absorb the cost of an additional payment surcharge for using a credit card. The present invention can account for this type of surcharge by evaluating the information in the buyer profile 516. For example, if a buyer specifies that they always want to pay by credit card, the pricing rules would incorporate a payment surcharge for credit card use into the total cost 526, if applicable.

The buyer profile 516 includes, but is not limited to, preferred form of payment, such as check, money order, or credit card, shipping preference, such as fastest, cheapest, or standard shipping, as well as preferences regarding shipping insurance. A preference such as “in-person” can indicate that the buyer will pick up the item at the seller's location, avoiding any shipping charges. In this case, the shipping charges are not included in the total cost. The pricing rules 500 can incorporate this information to compute the associated extra costs in addition to the sale price. While the pricing rules are evaluated by the price server 39, it is not mandatory to have a dedicated machine act as price server. It is possible to combine the price server functions into one of the other servers within the network-based transaction facility 10.

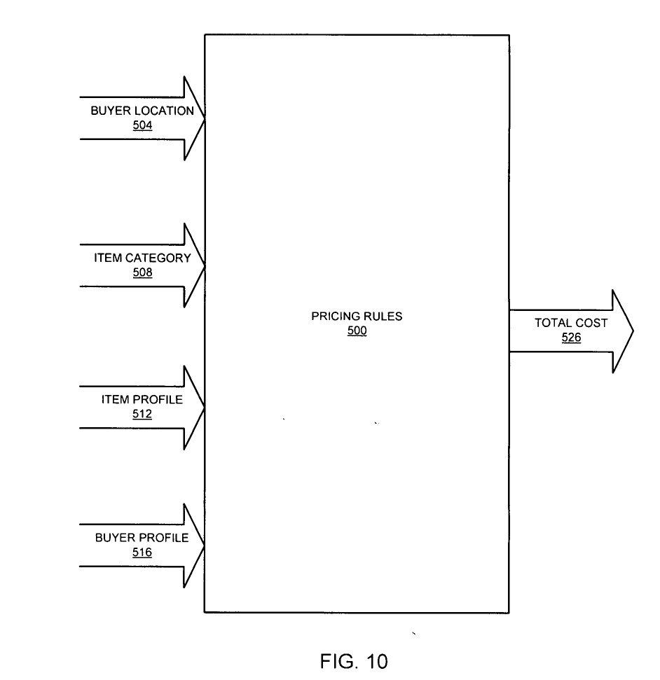

FIG. 11 shows an exemplary embodiment of a multi-item listing of the present invention which presents tax, shipping, and payment surcharge information. In this case, based on the buyer profile, the method of payment is credit card. As indicated in FIG. 3E, seller Edgar imposes a 3.0% surcharge on credit card purchases to be paid by the buyer. Therefore, the total cost of the item for sale by Edgar is now computed as $15.00+3.0% surcharge, or $15.45, and incorporates the payment surcharge in the amount of the credit card transaction fee. In the example shown in FIG. 11, an item for which a payment surcharge applies is indicated by the “(C)” next to the seller name of Edgar. However, an icon, or different font style or attribute could also be used to indicate an item for which a payment surcharge applies.

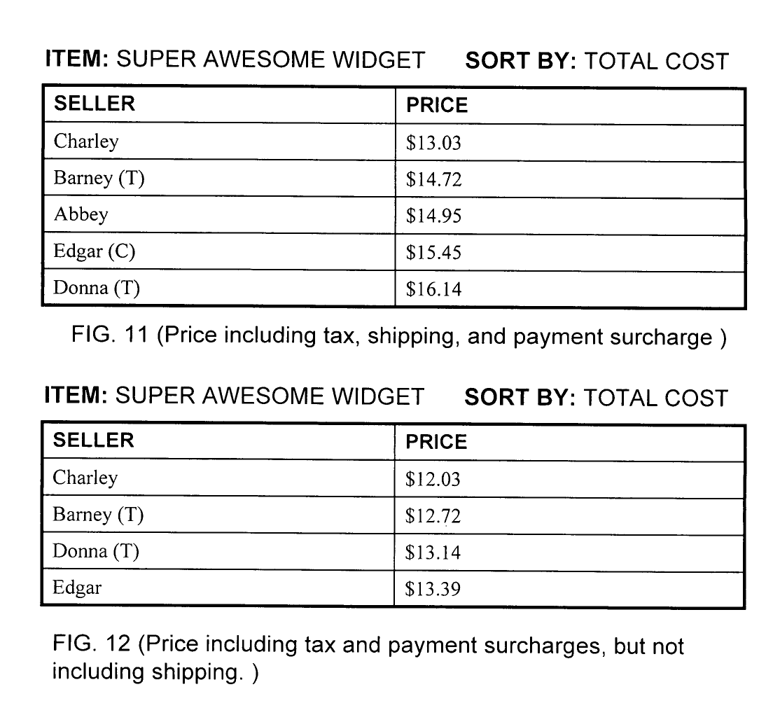

FIG. 12 shows an exemplary embodiment of a multi-item listing of the present invention which presents tax, and payment surcharge information, but does not include shipping. This is useful when a buyer desired to pick up the item in-person, to avoid shipping costs. Typically, the buyer will conduct a search of items within a nearby area, to avoid excessive travel to the seller's location. For example, in this case, the seller Abbey is not shown in the list since she is in Colorado, which is prohibitively far away for in-person pickup by buyer Frank, who is located in New Jersey. In this case, since the shipping charges are not included, seller Donna now has a lower total cost than seller Edgar, whereas in the previous example, seller Donna had the highest total cost. The flexibility to present a multi-item listing with the options provided by the present invention provides an improved buying experience in an online e-commerce system.

Thus, a method and system for price presentation in an online e-commerce system have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method for presenting a multi-item listing of items available for sale in an online e-commerce environment, comprising the steps of:
establishing at least one item profile;
establishing at least one buyer profile;
establishing a set of pricing rules;
calculating a total cost for each item in said multi-item listing, based on said item profile,
said buyer profile, and said pricing rules; and
displaying said total cost for each of said items,
whereby the said total cost is the amount of funds a buyer must incur to obtain each of said items is displayed.

2. The method of claim 1, wherein the step of calculating a total cost comprises the steps of:
calculating applicable taxes;
calculating payment surcharges; and
calculating the sum of the sales price, applicable taxes, and payment surcharges;
wherein said sum is the total cost.

3. The method of claim 1, wherein the step of calculating a total cost comprises the steps of:
calculating applicable taxes;
calculating payment surcharges;
calculating shipping charges; and
calculating the sum of the sales price, applicable taxes, shipping charges, and payment surcharges;
wherein said sum is the total cost.

4. A system for presenting a multi-item listing of items available for sale in an online e-commerce environment, wherein a total cost for each of said items is displayed, comprising a network-based transaction facility, a plurality of client computers connected to said network-based transaction facility via a communications network, wherein said network-based transaction facility contains a computer which performs the function of a price server, said price server executing computer instructions to evaluate pricing rules used to derive accurate assessments of the costs incurred by a buyer when purchasing an item from said online e-commerce system.

5. The system of claim 4, further comprising means for indicating items which are subject to a tax, if purchased.

6. The system of claim 5, further comprising means for indicating items which are subject to a payment surcharge, if purchased.

7. A client device displaying a multi-item listing of items available for sale in an online e-commerce environment, the total cost of each of said items, said total cost including sale price, applicable tax, applicable shipping charges, and applicable payment surcharges.

8. The client device of claim 7, further comprising an indicating means for indicating items that are subject to a tax, if purchased.

9. The client device of claim 7, further comprising an indicating means for indicating items that are subject to a payment surcharge, if purchased.
